(19) United States
(12) Patent Application Publication
(10) Pub. No.: US 2024/0313991 A1
(43) Pub. Date: Sep. 19, 2024

(54) ONLINE MEETING POSITIONINGS

(71) Applicant: Hewlett-Packard Development Company, L.P., Spring, TX (US)

(72) Inventors: Hsiao-Ling Hsieh, Taipei City (TW); Chung-Chun Chen, Taipei City (TW); Wei-Ming Lo, Taipei City (TW)

(73) Assignee: Hewlett-Packard Development Company, L.P., Spring, TX (US)

(21) Appl. No.: 18/183,069

(22) Filed: Mar. 13, 2023

(51) Int. Cl. H04L 12/18

(52) U.S. Cl. CPC H04L 12/1818; H04L 12/1827; H04L 65/403

(57) ABSTRACT

A video conferencing system including a plurality of ultra-wideband (UWB)-enabled electronic devices and a camera can facilitate a better conference call experience for participants. Each electronic device can determine its relative location by performing a UWB exchange with the camera. A conference call application uses the relative locations of each electronic device to generate an ordered listing of conference participants. The electronic devices adjust a graphical user interface (GUI) of conference participants based on the ordered listing. When one of the electronic devices detects an audio input from a corresponding conference participant, the electronic device can selectively provide audio information to the conference call application and request that the camera zoom to the electronic device. The camera can accordingly zoom a video input of the conference call application to emphasize the corresponding participant in the conference call.

### BACKGROUND

A video conferencing system can include a number of electronic devices that exchange information among a group of participants. Examples of electronic devices include, but are not limited to, mobile phones, tablets, base stations, network access points, customer-premises equipment (CPE), laptops, cameras, and wearable electronics. In some scenarios, electronic devices can include input devices, output devices or a combination that allow for the exchange of content in the form of audio, video, or a combination of audio and video data. The exchange of the content may be facilitated through software applications, generally referred to as conference applications, communication networks, and network services.

### BRIEF DESCRIPTION OF THE DRAWINGS

FIG. 1 is a schematic representation of an example of a video conferencing system;

FIG. 2A is a schematic representation of an example of a camera device of the video conferencing system of FIG. 1;

FIG. 2B is a schematic representation of an example of a computing device of the video conferencing system of FIG. 1;

FIGS. 3A-3C are schematic representations of an example video conferencing system illustrating the adjustment of a graphical user interface (GUI) of a conference call application based on location information of a plurality of computing devices;

FIGS. 4A-4C are schematic representations of an example video conferencing system illustrating the adjustment of a GUI generated by a conference call application on an electronic device based on location information and audio input information of a plurality of computing devices;

FIGS. 5A-5B are flow diagrams of example methods for adjusting the graphical user interface generated by a conference call application on an electronic device; and

FIGS. 6A-6C illustrate various examples of graphical user interfaces generated by an electronic device in accordance with a conference call example.

### DETAILED DESCRIPTION

Certain examples described herein provide a system and method for facilitating conference calling functionality between electronic devices. Generally, aspects relate to the utilization of electronic devices including ultra-wideband camera (UWB) functionality in conferencing examples. Such aspects can include, but are not limited to using UWB communications in detecting location and distance of electronic devices relative to a camera device and causing the modification of graphical user interfaces (GUIs) of a conference call applications to incorporate relative location of the electronic devices to the camera device or other electronic devices. Other aspects further include using UWB communications in detecting sources of audio input and causing modification of GUIs of the conference call applications reflective of a characterization of a source of audio input.

With reference to the previous general example, when multiple participants (users) are participating in a video conference call (also referred to as a virtual meeting), a video conference call service can generate graphical user interface (GUI) information that can be rendered on individual computing device. The GUI information can visually depict individual participants in a conference call application, including identification information, video and audio data transmitted by the camera device or other electronic device(s), and various controls. Such conference call applications can include Cisco Webex™, Microsoft Teams™, Zoom™, and the like.

Typically, for an individual conference call session, the conference call application GUIs can include a layout to display one or more of the conference participants. Such layouts can include an arrangement of windows (or sub-windows), often in the form of a linear alignment of windows or matrix alignment of windows, depending on the number of electronic devices that are participating in an individual conference call session. In some scenarios, multiple electronic devices may be located within a common geographic area, such as conference room in which the electronic devices may be an individual part of the conference call session in conjunction with other electronic devices, such as a camera device. In at least these type of scenarios, the arrangement of windows (or sub-windows) of the generated GUIs does not typically process a relative physical location of electronic devices (and associated participants) in the common area. Rather, in such scenarios, the arrangement of windows (or sub-windows) may be based on other sorting criteria, such as alphabetical listing of participant identifiers, order of connection to the conference call session, type of device functionality (e.g., video only, audio only, audio/video combination), and the like. Additionally, in some embodiments, the GUIs generated by a plurality of participants can be individualized such that the order and arrangement of windows (or sub-windows) may be different for individual participants.

Accordingly, the representation of relative location of participants in a common area (e.g., a conference room) can be limited to a single camera device that does not allow for the utilization (e.g., inputs) of individual computing devices. Such limitation can further make the operation of the conference call session inefficient due more limited inputs for the conference participants or the elimination of relative location information from conference call session information.

The aforementioned challenges, among others, are addressed in some examples by the disclosed techniques for displaying and managing GUIs generated during conference call session by determining and incorporating relative physical locations of at least a portion of individual computing devices participating in the conference call session. The display and management of the GUIs can include an automatic arrangement of electronic devices (and associated participants) that are in a common area (e.g., a conference room) and detectable by a camera device having UWB functionality. The display and management of GUIs can also include an automatic arrangement of participants in a conference call session to coincide with a video feed and an audio feeds to the conference call application and which prioritize a participant who is currently generating audio inputs (e.g., speaking). These techniques can facilitate an improved experience for conference call participants by more closely resembling the experience of a meeting conducted face-to-face.

Examples described herein provide a video conferencing system capable of updating a GUI of a conference call application based on location information of a plurality of electronic devices that are associated or attributed to a plurality of conference participants. For example, an electronic device can include an ultra-wideband (UWB) sensor; and a processor to determine, via the UWB sensor, a location of a camera relative to the electronic device and a location of the electronic device relative to the camera; and adjust a graphical user interface (GUI) of a conference call application based on the location of the electronic device, wherein the GUI is to be shown by the electronic device. The GUIs shown by the individual electronic devices may have at least a common portion, namely, the arrangement of windows (or sub-windows) illustrative of determined relative location of electronic devices detected in a common area.

In another example, an electronic device described herein can include a microphone; an ultra-wideband (UWB) sensor; and a processor to determine a location of a camera relative to the electronic device and a location of the electronic device relative to the camera using UWB sensor information; receive an audio input by the microphone; and adjust a graphical user interface (GUI) of a conference call application based on the location of the electronic device and the audio input, wherein the GUI is to be shown at the electronic device.

In yet another example, an electronic device can include an imaging sensor; an ultra-wideband (UWB) sensor; and a controller to determine, via the UWB sensor, a location of a computing device relative to the electronic device; and transmit the location to the computing device.

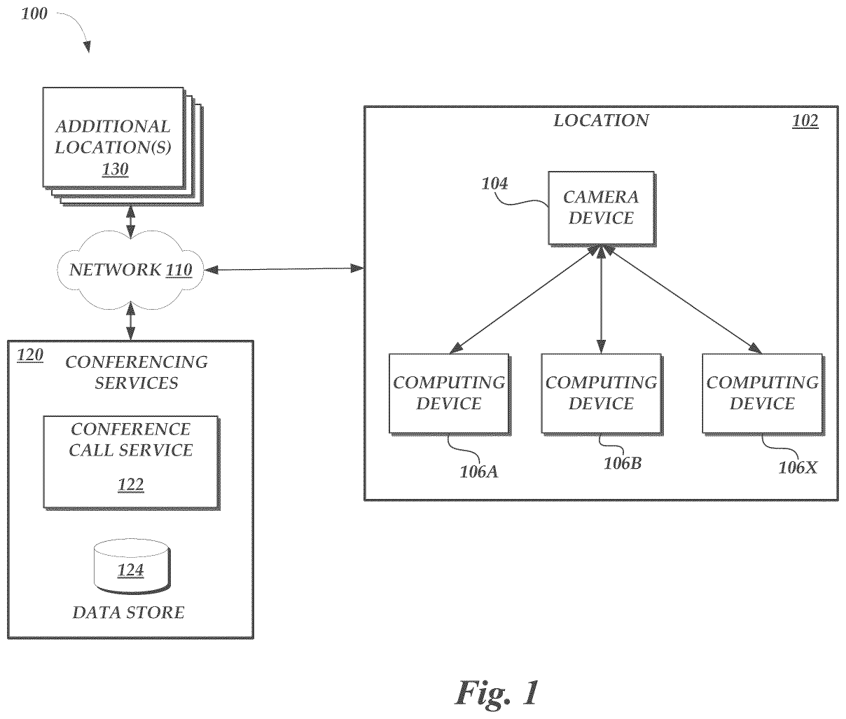

FIG. 1 is a schematic representation of one example of a video conferencing system 100. The video conferencing system 100 includes a plurality of first electronic devices (hereafter referred to as computing devices 106). Individually, each of the plurality of computing devices 106 communicatively connected to a second electronic device (hereafter referred to as the camera, or camera device 104). The plurality of computing devices 106 and the camera device 104 are positioned in a first location 102, such as a conference room, classroom, or other meeting location. The plurality of computing devices 106 and the camera device 104 are ultra-wideband (UWB)-enabled devices to facilitate a wireless connection between the computing devices 106 and the camera device 104. For purposes of illustration, the association of the computing devices 106A, 106B, 106X is logical in nature and may be defined by computing devices 106 that may be detected or in the line-of-sight of the camera device 104. Although three computing devices 106A, 106B, 106X are illustrated in FIG. 1, one skilled in the relevant art will appreciate that aspects of the present application may be implemented with individual computing devices 106 or any number of computing devices. Accordingly, the specific logical arrangement of electronic devices 106A, 106B, or 106X should not be construed as limiting.

The camera device 104 can be positioned within the first location 102 such that the plurality of computing devices 106 are framed within a field-of-view (FoV) of the camera device 104 that allows for individual computing devices to be considered or characterized as being in a line-of-sight of the camera device 104. Illustratively, the arrangement of computing devices 106A, 106B, and 106X may correspond to various degrees of FoV, including less than 180 degrees FoV and an associated line-of-sight access, or greater than 180 degrees FoV and associated line-of-sight access. For example, the camera device 104 can be mounted to a ceiling or wall of a room comprising the first location 102. In some examples, the camera device 104 can have a fixed location relative to the computing devices 106. In other example, the camera device 104 may have functionality that provides for automated or manual adjustment of the camera device location (relative to the computing devices 106) or the FoV of the camera device 104.

The camera device 104 captures a video input of the first location 102 by an image sensor. For purposes of illustrative examples, the positioning of the camera device 104 can also provide a UWB line-of-sight connection between the camera device 104 and each of the plurality of computing devices 106. In some cases, a direct line-of-sight between the camera device 104 and one of the computing devices 106 may not be available, however, a UWB connection can still be established that allows for the exchange of information between the camera device 104 and an individual computing device 106 as described herein. As is discussed herein, the camera device 104 and each of the plurality of computing devices 106 can include a conference call application resident in non-volatile memory, including instructions to be executed by a processing unit of the corresponding electronic device.

For purposes of illustration, the video conferencing system 100 can also include one or more additional location(s) 130 that are in networked communication with conferencing services 120 of the conference call application by a computer network 110. The computer network 110 can be a LAN, WAN, WLAN, or other type of network. The additional locations may also include an arrangement of electronic devices 106 (not shown) in a common location, individual computing devices 106 or a combination thereof. Any computing devices 106 in the additional locations 130 would illustratively receive the GUIs or modified GUIs as described herein that represent the relative location of the electronic devices 106A, 106B, 106X. Similarly, although not described in greater detail, the additional locations 130 may also implement aspects of the present application such that relative locations of computing devices 106 in the additional locations may also be represented in GUIs. Thus, at least portions of one or more aspects of the present application may replicated or duplicated in multiple locations in some examples.

The conferencing services 120 can be hosted, for example, on a remote server or cloud server responsible for managing audio and video connectivity between the first location 102 and additional location(s) 130 via the network 110. The conferencing services 120 include a conference call service 122 which, in some cases, can be accessed by an application programming interface (API) via the conference call application of the camera device 104 or any one of the plurality of computing devices 106. The conferencing services 120 can further include a data store 124 to record video and/or audio information of the conference call service 122. In some cases, the data store 124 can cache video and/or audio information to improve network performance and reduce latency of data exchange between the first location 102 and additional location(s) 130.

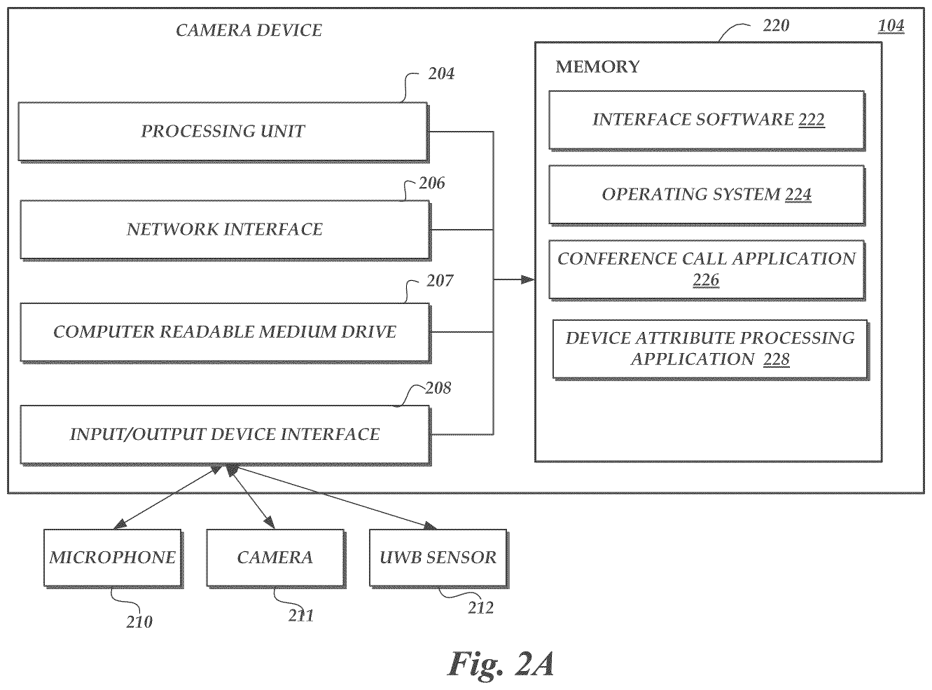

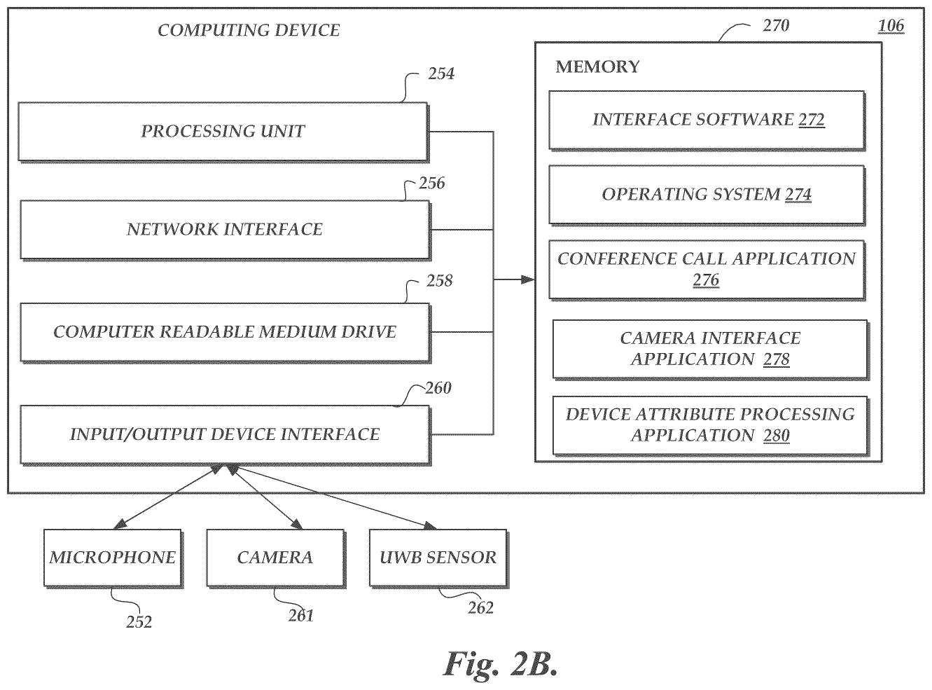

FIG. 2A depicts an example of an architecture of the camera device 104. The general architecture of the camera device 104 depicted in FIG. 2A includes an arrangement of computer hardware and software components that may be used to implement aspects of the video conferencing system of FIG. 1. As illustrated, the camera device 104 includes a processing unit 204, a network interface 206, a computer readable medium drive 207, an input/output device interface 208, input devices (such as a microphone 210, camera module 211, and UWB sensor 212), and an optional display, all of which can communicate with one another by way of a communication bus. In various examples, components such as the display or input devices can be integrated into the camera device 104, or they may be external components that are coupled to the camera device 104.

The network interface 206 can provide connectivity to one or more networks or computing systems, such as the network 110 of FIG. 1. The processing unit 204 can thus receive information and instructions from other computing systems or services via a network. The processing unit 204 can also communicate to and from a memory 220 and further provide output information for the optional display via the input/output device interface 208. The input/output device interface 208 can also accept input from the optional input device, such as a keyboard, mouse, digital pen, etc. In some cases, the camera device 104 may include more (or fewer) components than those shown in FIG. 2A.

The memory 220 can include computer program instructions that the processing unit 204 executes in order to implement one or more examples of the video conferencing system. The memory 220 generally includes RAM, ROM, or other persistent or non-transitory memory. The memory 220 can store an operating system 224 that provides computer program instructions for use by the processing unit 204. The memory 220 can further include computer program instructions and other information for implementing aspects of the video conferencing system. For example, the memory 220 includes interface software 222 for communicating with the computing devices 106 or the conferencing services 120 by the network 110. The memory 220 can further include the conference call application (e.g., a first conference call application client 226 for transmitting input information of the camera module 211 and UWB sensor 212 to the conference call service 122). Additionally, the memory 220 can include a device attribute processing application 228 for calculating location information of the plurality of computing devices 106 and/or the camera device 104 as is discussed herein.

FIG. 2B depicts an example of an architecture of a computing device 106 of the plurality of computing devices 106. The general architecture of the computing device 106 depicted in FIG. 2B includes an arrangement of computer hardware and software components that may be used to implement aspects of the video conferencing system of FIG. 1. As illustrated, the computing device 106 includes a processing unit 254 (also referred to generally as a processor or controller), a network interface 256, a computer readable medium drive 258, an input/output device interface 260, input devices (such as a microphone 252, camera module 261, and UWB sensor 262), and an optional display, all of which can communicate with one another by way of a communication bus. In various examples, components such as the display or input devices can be integrated into the computing device 106, or they may be external components that are coupled to the computing device 106. For example, the camera module 261 can be the camera device 104 in networked communication with each one of the plurality of computing devices 106.

The network interface 256 can provide connectivity to one or more networks or computing systems, such as the network 110 of FIG. 1. The processing unit 254 can thus receive information and instructions from other computing systems or services via a network. The processing unit 254 can also communicate to and from a memory 270 and further provide output information for the optional display via the input/output device interface 260. The input/output device interface 260 can also accept input from the optional input device, such as a keyboard, mouse, digital pen, etc. In some cases, the computing device 106 may include more (or fewer) components than those shown in FIG. 2B.

The memory 270 can include computer program instructions that the processing unit 254 executes in order to implement one or more examples of the video conferencing system. The memory 270 generally includes RAM, ROM, or other persistent or non-transitory memory. The memory 270 can store an operating system 274 that provides computer program instructions for use by the processing unit 254. The memory 270 can further include computer program instructions and other information for implementing aspects of the video conferencing system. For example, the memory 270 includes interface software 272 for communicating with the camera device 104 or the conferencing services 120 by the network 110. The memory 270 can further include the conference call application (e.g., a second conference call application client 276) for transmitting input information of the microphone 252, camera module 261, and UWB sensor 262 to the conference call service 122. Additionally, the memory 270 can include a camera interface application 278 for communicating with the external camera device 104. The memory 270 can also include a device attribute processing application 280 for calculating location information of the plurality of computing devices 106 and/or camera device 104 as is discussed herein.

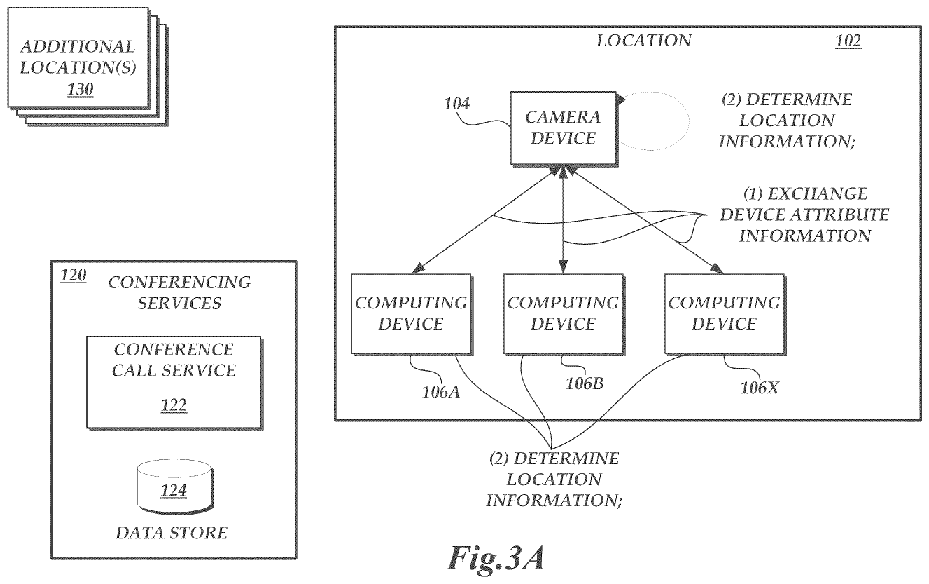

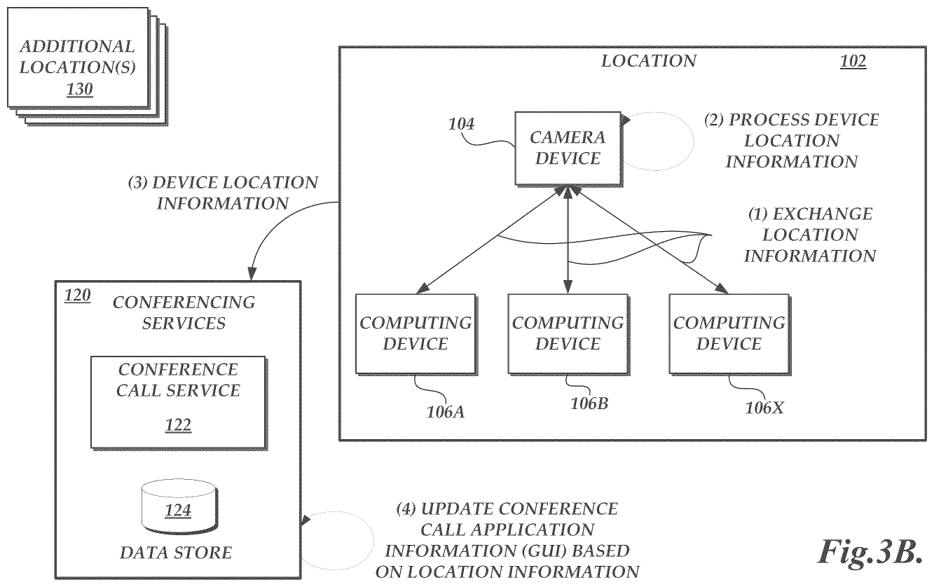

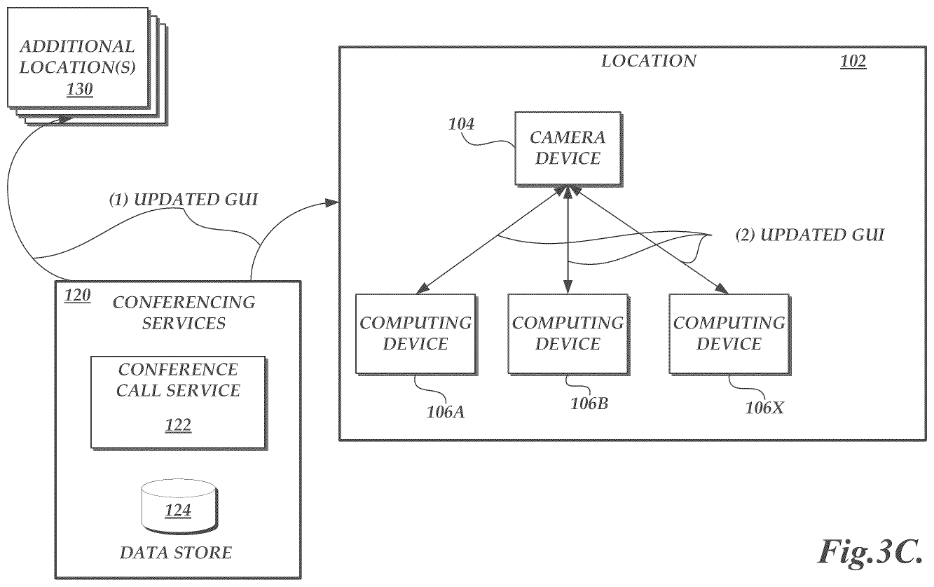

Referring now to FIGS. 3A-3C, schematic representations of an example video conferencing system illustrating the adjustment of a GUI of the conference call application client 226, 276 shown by each of the plurality of computing devices 106 (including computing devices 106A, 106B, and 106X of FIG. 2B) is discussed. For purposes of illustration, FIGS. 3A-3C may omit some interactions or data exchange, such as log-in procedures, authentication procedures, error correction procedures, and the like, that may also be incorporated in accordance with implementations of the exemplary interactions. Additionally, reference to one computing device 106 may be interpreted to be individually executed by each of the computing devices 106A, 106B, 106X or sub-combinations thereof.

With reference to FIG. 3A, at (1) the plurality of computing devices 106 performs a UWB exchange with the UWB-enabled camera device 104 to determine a location of the camera device 104 relative to the respective computing device 106 and a location of the computing device 106 relative to the camera device 104. The UWB exchange can include measuring, by the UWB sensor of the computing device 106 and/or the UWB sensor of the camera device 104, time-of-flight (ToF) information and angle-of-arrival (AoA) information associated with individual UWB signals exchanged between the computing device 106 and the camera device 104. The illustrative exchange of information between the camera device 104 and the individual computing devices 106A, 106B, 106X may be conducted in parallel (as illustration) or alternatively in some form of sequential manner.

At (2), the processing unit 254 of the computing devices 106 and the camera device 104 can then calculate location information corresponding to a ToF delay and a AoA phase difference associated with the individual UWB signals, and calculate a direction and a distance of the camera device 104 relative to the respective computing device 106. The processing of the location information may be completed by the computing devices 106 individually, the camera device 104, or in combination.

In some cases, the plurality of computing devices 106 may use only ToF delay calculations to determine the location of either device. In another example, the plurality of computing devices 106 can communicate directly with one another by performing successive UWB exchanges to acquire a location of each of the computing devices 106 in addition to the location of the camera device 104. This can also help to resolve a more accurate location of the camera device 104 by comparing location data calculated by one computing device 106 with location data calculated by the plurality of other computing devices 106.

Turning to FIG. 3B, at (1), the camera device 104 exchanges or receives determined location information from individual computing devices 106 (e.g., computing devices 106A, 106B, 106X). At (2), the camera device the processes the individual location information determined and transmitted by the computing devices 106. At (3), the determined or processed device location information comprising the relative locations of the camera device 104 and the computing device(s) 106 is transmitted from the processing unit 204 or 254 to the conferencing services 120 via the network 110. In one example, the camera device 104 can be responsible for compiling device location information from each of the plurality of computing devices 106 and transmitting the information to the conference call service 122 by the API of the conference call application. In another example, each of the plurality of computing devices 106 can individually transmit its own device location information to the conference call service 122.

At (4), the conference call service 122 of the conferencing services 120 is responsible for managing an order of conference participants in the conference call application GUI based on the device location information. Each of the plurality of computing devices 106 receives updated conference call application information via the API to periodically adjust the conference call application GUI displayed by the computing device 106. For example, if a first conference participant is sitting at a table and associated with a first computing device 106A, and a second conference participant is sitting at the table associated with a second computing device 106B, the conference call service 122 can generate an ordered listing of the participants corresponding to the relative locations of each computing device 106A and 106B from the perspective of the camera device 104. Accordingly, the GUIs will automatically be adjusted to the relative location of the computing devices 106A and 106B while allowing the participants to use the computing devices 106A, 106B for inputs.

Turning now to FIG. 3C, the updated or managed GUI information is transmitted to individual computing devices 106. Illustratively, each individual computing device 106 can acquire the ordered listing of participants by the conference call API, and each device 106 adjusts its own conference call GUI to display the participants in the same order.

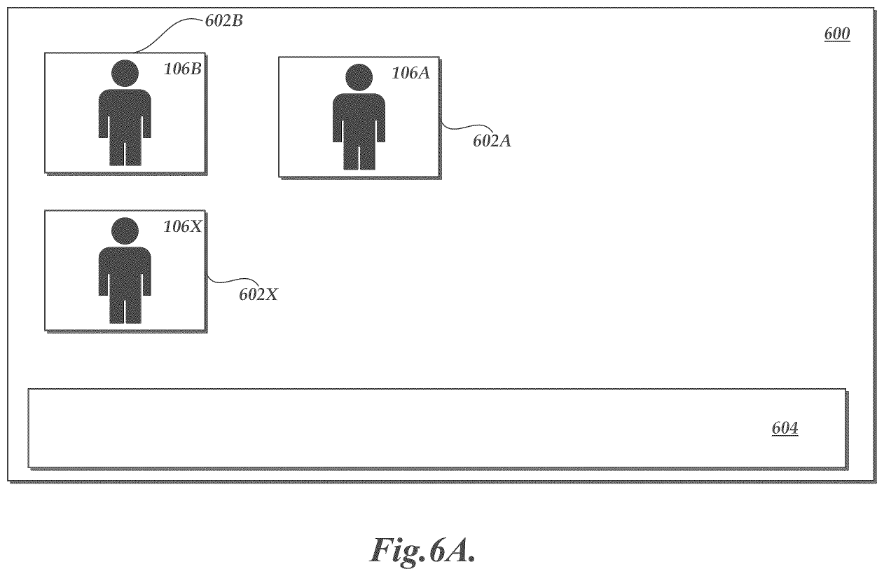

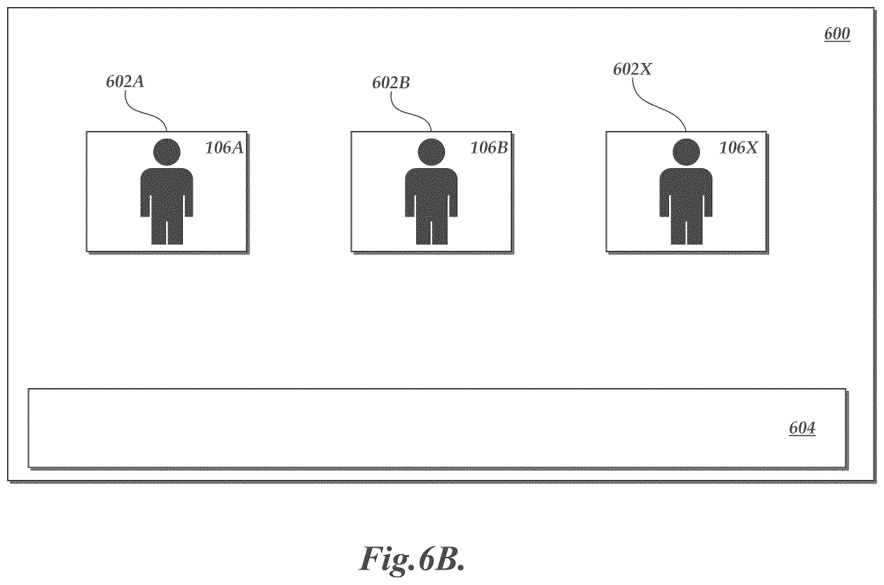

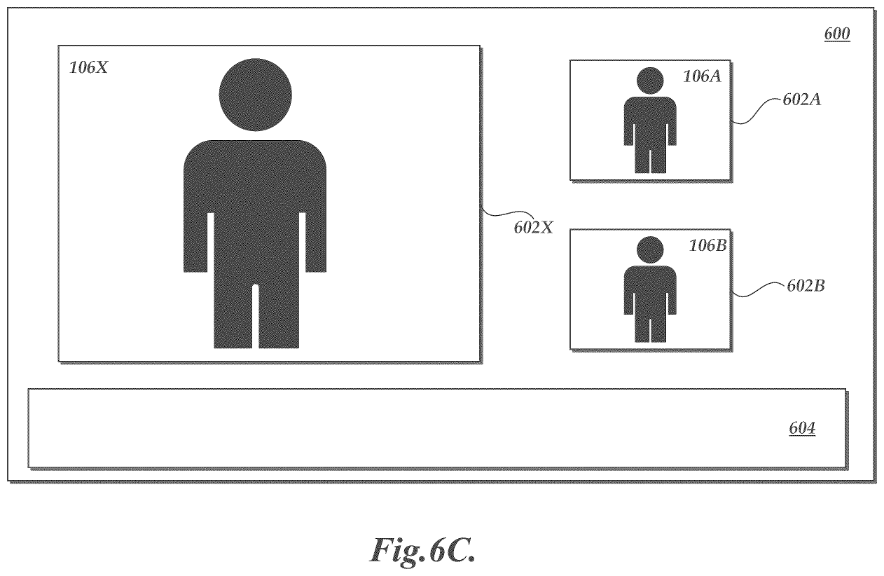

In an additional example, components of the conference call service 122 responsible for managing the ordered listing can be implemented by the camera device 104 or one of the computing devices 106. The conferencing services 120 can return the ordered listing of participants not only to the devices 104, 106 of the first location, but also to the additional devices 104, 106 at any additional location(s) 130 for a more consistent video conferencing experience. Examples of GUIs corresponding to the automatic adjustment of windows (or sub-windows) based on the interactions illustrated in FIGS. 3A-3C will be described below with regard to FIGS. 6A and 6B.

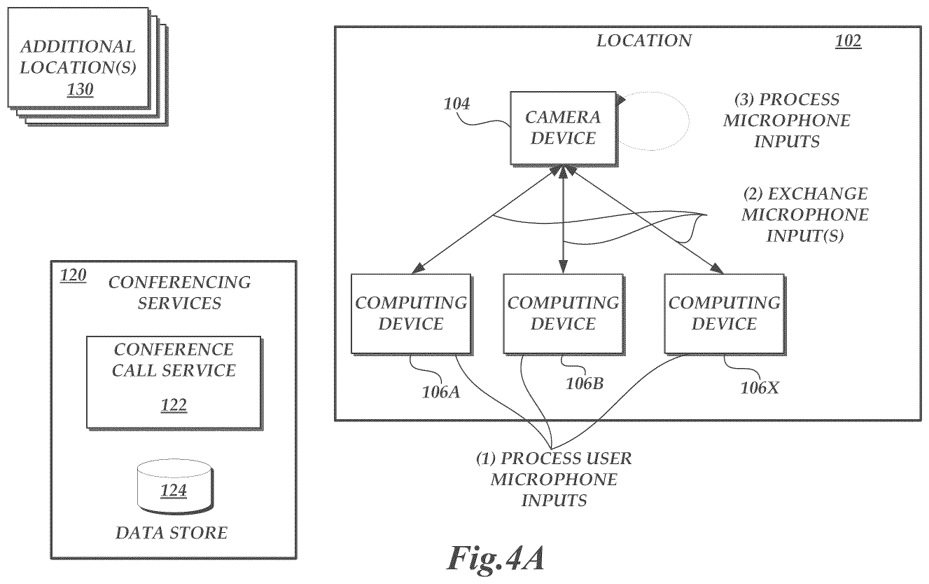

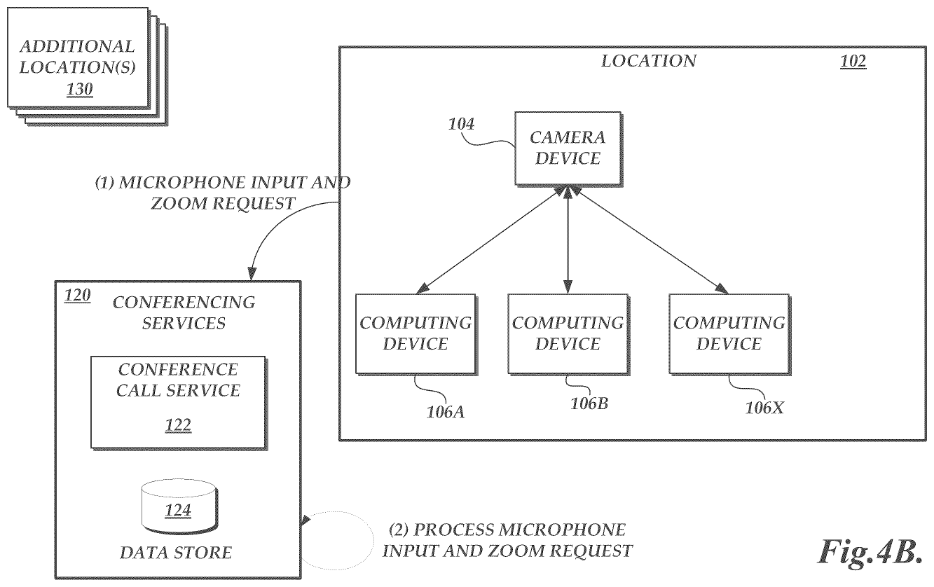

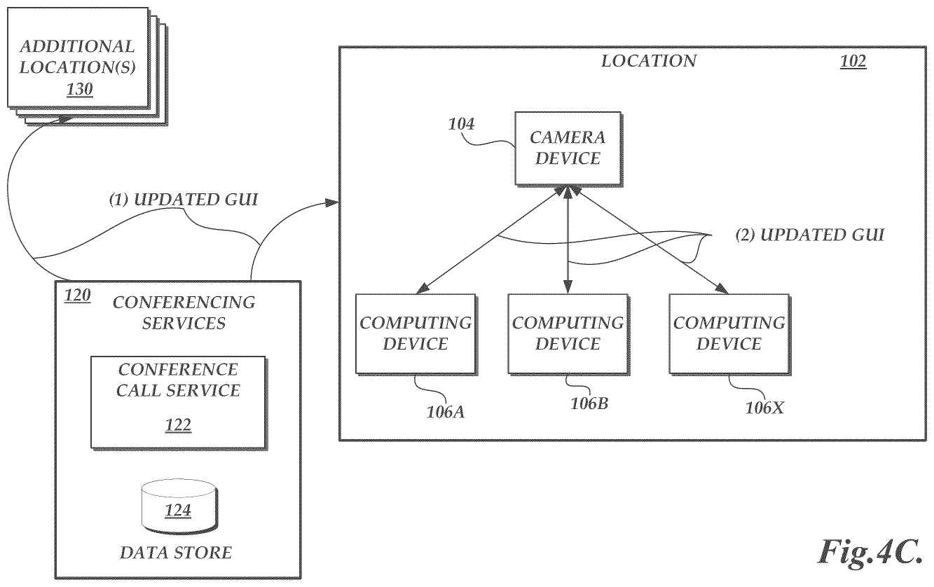

FIGS. 4A-4C are schematic representations of an example video conferencing system illustrating the adjustment of the GUI of the conference call application based on location information and an audio input of the plurality of computing devices 106. Those skilled in the art will appreciate that the audio input information can be used in combination with the device location information of FIGS. 3A-3C to emphasize an active participant in the conference call as is discussed herein. Similar to the interaction described in FIGS. 3A-3C, for purposes of illustration, FIGS. 4A-4C may omit some interactions or data exchange, such as log-in procedures, authentication procedures, error correction procedures, and the like, that may also be incorporated in accordance with implementations of the exemplary interactions. Additionally, reference to computing device 106 may be interpreted to be individually executed by each of the computing devices 106A, 106B, 106X or sub-combinations thereof.

With reference to FIG. 4A, one or more of the plurality of computing devices 106 may detect or otherwise receive an audio input, such as by an individual microphone 252. The processing unit 254 can process the audio input by any signal conditioning or filtering technique known to those skilled in the art, such as a noise gate filter. For example, the processing unit 254 can reject background noise and interruptions while preserving a voice of the conference participant proximal to the computing device 106. The microphone 252 can be a directional microphone to selectively receive audio input from the direction of the conference participant. In some cases, a conference participant's voice may be picked up by the microphones 252 of multiple computing devices 106, and the processing unit 254 of the computing device 106 which is not nearest to the participant can reject the duplicate audio input.

At (2), one or more of the computing devices 106 exchange the audio inputs of each microphone 252 with the camera device 104. In some cases, the camera device 104 can receive a continuous microphone input audio stream from each computing device 106. At (3), the processing unit 204 of the camera device 104 can perform signal processing techniques on each audio stream remotely. In other cases, the computing devices 106 can each perform audio filtering locally, and only transmit the microphone input audio stream to the camera device 104 when the audio input exceeds an audible threshold.

With reference to FIG. 4B, when the audio input exceeds an audible threshold at one of the plurality of computing devices 106, at (1), the corresponding computing device 106 can transmit device location information (previously determined by a UWB exchange with the camera device 104 in FIG. 3B) and a request for camera zoom to the camera device 104. The camera device 104 can be a motorized or otherwise controllable camera unit, which modifies the field-of-view of the video input toward the corresponding computing device 106 responsive to a request for camera zoom. The request for camera zoom may include instructions relating to zoom, crop, focus, or other parameters of the video input of the camera device 104.

At (2), in some cases, the request for camera zoom can be processed by the conference call service 122 of the conferencing services 120. For example, the conference call service 122 can receive a microphone input audio stream and a request for camera zoom from one or more of the computing devices 106 via the conference call API. The conference call service 122 processes the audio stream(s) to determine which microphone audio input corresponds to a conference participant who is currently speaking, and can forward the appropriate request for camera zoom to the camera device 104. In other cases, this processing functionality can be implemented directly at the camera device 104.

Turning to FIG. 4C, at (1), when the computing device 106 corresponding to the conference participant who is currently speaking has been identified, the conference call service 122 generates the ordered listing of conference participants as discussed herein. The ordered listing can designate one of the participants in the ordered listing as the speaker, and when each computing device 106 receives the ordered listing, can adjust the conference call application GUI to emphasize the speaker accordingly. An example of a GUI corresponding to the automatic adjustment of windows (or sub-windows) based on the interactions illustrated in FIGS. 4A-4C will be described below with regard to FIG. 6C.

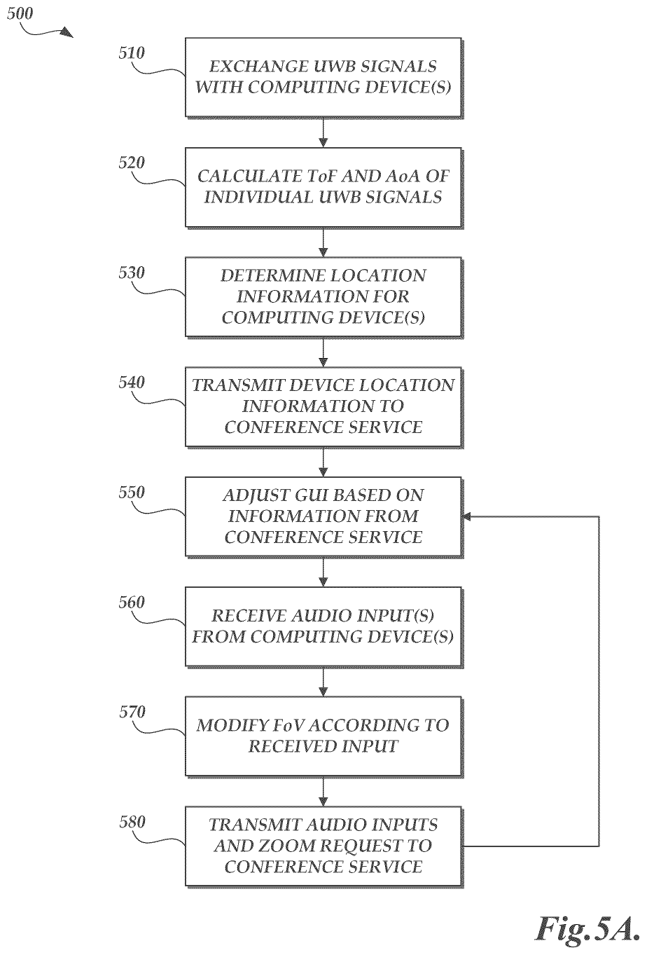

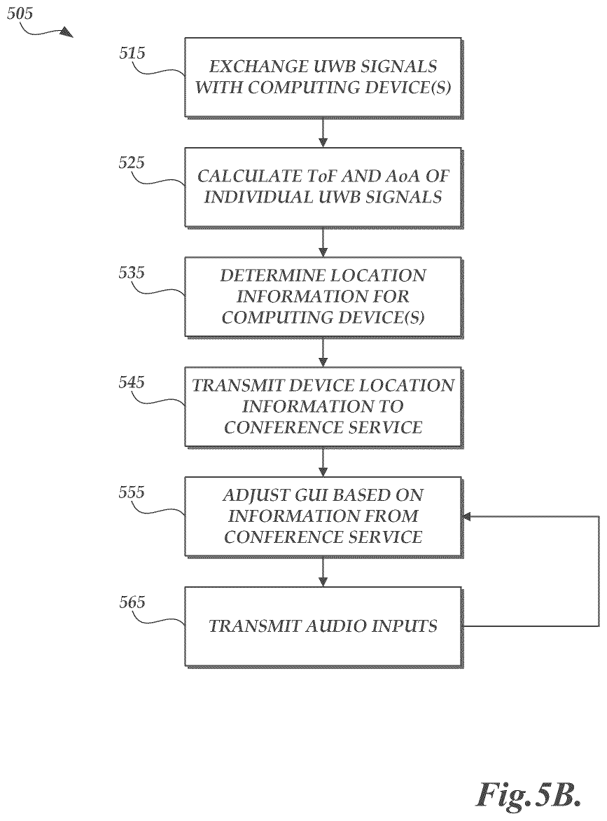

With reference now to FIGS. 5A and 5B, flow diagrams of example methods for adjusting the graphical user interface generated by a conference call application on an electronic device will be described. FIG. 5A illustrates a method 500 for adjusting the GUI of the conference call application according to any of the previous figures. The method 500 of FIG. 5A may be illustratively implemented by the camera device 104 as discussed herein.

At block 510, the camera device 104 performs, by the UWB sensor, the UWB exchange with each of the plurality of computing devices 106. At block 520, the processing unit 204 of the camera device 104 can calculate or determine location attribute information. Illustratively, the location attribute information can include, but is not limited to, ToF and AoA information associated with individual UWB signals exchanged with each computing device 106.

At block 530, the processing unit 204 can further determine a location of each of the plurality of computing devices 106 relative to the camera device 104. The processing unit 204 can also determine a location of the camera device 104 relative to each of the computing devices 106. Illustratively, the relative location information is based on the determined location attribute information (e.g., the ToF information, AoA information, or a combination thereof).

At block 540, the device location information is transmitted, by the network 110, to the conferencing services 120 of the conference call application. At block 550, the camera device 104 receives, by the network 110, an ordered listing of participants from the conferencing services 120, which may then be used to adjust a GUI of the conference call application (e.g., shown on a display of the camera device 104 and computing devices 106).

As discussed herein, the method 500 can further include adjusting the conference call application GUI based on audio input information from one of the computing devices 106. At block 560, the camera device 104 can receive a microphone audio input and a request for camera zoom from any one of the computing devices 106. At block 570, the camera device 104 can modify the field-of-view of the image sensor to correspond to the location of the corresponding computing device 106. Block 570 may be considered optional and the camera device 104 may not need to adjust field-of-view information. At block 580, the camera device 104 can transmit the microphone audio input and request for camera zoom to the conferencing services 120. Illustratively, the method 500 returns to block 550 for receipt of updated GUI information and can be continuously processed for a conference call session. Additionally, in some examples, blocks 510-540 may also be repeated based on movement of computing devices 106 or the method may be restarted.

FIG. 5B illustrates steps of another method 505 for adjusting the GUI of the conference call application. The method 505 of FIG. 5B is implemented by one of the plurality of computing devices 106 as discussed herein.

At block 515, the computing device 106 performs, by the UWB sensor, the UWB exchange with the camera device 104. At block 525, the processing unit 254 of the computing device 106 can calculate location attribute information, including, but not limited to, ToF and AoA information associated with individual UWB signals exchanged with the camera device 104.

At block 535, the processing unit 254 can determine a location of the camera device 104 relative to the computing device 106 and a location of the computing device 106 relative to the camera device 104. The determined location can be based, at least in part, on the ToF and AoA information. At block 545, the device location information is transmitted, by the network 110, to the conferencing services 120 of the conference call application. At block 555, the computing device 106 receives, by the network 110, an ordered listing of participants from the conferencing services 120, which may then be used to adjust a GUI of the conference call application. At block 555, the method can further include adjusting the conference call application GUI based on audio input information from the computing device 106. For purposes of additional example, the method 505 can further include block 565, which includes transmitting, by the computing device 106, a microphone audio input and a request for camera zoom to the camera device 104. If not performed by the camera device 104, the computing device 106 can also forward the audio input and request for camera zoom to the conferencing services 120 by the network 110.

FIGS. 6A-6C illustrate various examples a conference call GUI 600. In one example (FIG. 6A), conference participants each corresponding to one of the plurality of computing devices 106A, 106B, and 106X are displayed as windows 602A, 602B, and 602X (respectively) in a two-dimensional grid layout. For purposes of illustration, in a first example, the ordering of windows 602A, 602B, and 602X may not represent the relative location of the computing devices 106A, 106B, and 106X (FIG. 1). The grid layout may correspond to a physical layout of the computing devices 106 in the first location 102, such as where the participants are seated at rows and columns of desks in a classroom.

With reference now to FIG. 6B, after the execution of illustrative methods 500 and 505, the GUI 600 may be updated or a new GUI may be generated reflective of the relative determined location of conference participants. The conference participants are displayed in a single row based on the locations of the computing devices 106A, 106B and 106X from the perspective of the camera device 104. This is useful where, for example, the participants are seated around a table facing toward the camera device 104. By selecting a layout of the conference call GUI 600 which is analogous to the physical layout of the first location 102, nonverbal communication and ease of identifying each participant in the video conference is improved.

Those skilled in the art will appreciate that although the conference call GUI 600 can take on various layouts according to the nature of the first location 102 and configuration of the computing devices 106, the order of participants can be distilled into an ordered list (such as an array or other data structure) exchanged between the conferencing services 120 and each computing device 106 or camera device 104. The ordered list may include additional parameters such as a preconfigured preferred layout (such that the conference call GUI 600 is displayed identically by each computing device 106), or an indication that one of the participants is to be emphasized as the speaker.

FIG. 6C is an example of a hybrid GUI layout for the participants of the conference call, where one or more participants (e.g., a speaker corresponding to the computing device 106X) is displayed more prominently. The role of the speaker in the conference call, window 602X, may rapidly change, and the conference call GUI 600 can be updated by the conferencing services 120 based on audio input information from each of the computing devices 106. The camera device 104 is zoomed such that the field-of-view of the video input to the conference call application captures a portion (e.g., a head and torso) of the speaker while cropping out any adjacent participants. In some cases, the video input from the camera device 104 is reserved for the current speaker, while video inputs for other conference participants may be received from their corresponding computing devices 106A, 106B.

The principles of the examples described herein can be used for any other system or apparatus including mobile phones, tablets, base stations, network access points, customer-premises equipment (CPE), laptops, cameras, and wearable electronics.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled,” as generally used herein, refers to two or more elements that can be either directly connected, or connected by way of one or more intermediate elements. Likewise, the word “connected,” as generally used herein, refers to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “may,” “could,” “might,” “can,” “e.g.,” “for example,” “such as” and the like, unless specifically stated otherwise, or otherwise understood within the context as used, is generally intended to convey that certain examples include, while other examples do not include, certain features, elements and/or states. Thus, such conditional language is not generally intended to imply that features, elements and/or states are in any way required for one or more examples or that one or more examples necessarily include logic for deciding, with or without author input or prompting, whether these features, elements and/or states are included or are to be performed in any particular example.

1. An electronic device comprising:
an ultra-wideband (UWB) sensor; and
a processor to:
determine, via the UWB sensor, a location of a camera relative to the electronic device and a location of the electronic device relative to the camera;
transmit location information of the electronic device to a conference host device:
receive relative location information of two or more participant electronic devices in networked communication with the conference host device, wherein the relative location information describes a location of each of the participant electronic devices relative to the location of the electronic device; and
adjust a graphical user interface (GUI) of a conference call application based on the location of the electronic device and the relative location information, wherein the GUI is to be shown by the electronic device.

2. The electronic device of claim 1, wherein the processor is to determine the location of the camera relative to the electronic device by:
measuring time-of-flight (ToF) information and angle-of-arrival (AoA) information associated with individual UWB signals exchanged with the camera;
calculating a ToF delay and an AoA phase difference associated with the individual UWB signals exchanged with the camera; and
calculating, from the ToF delay and the AoA phase difference, a direction and a distance of the camera relative to the electronic device.

3. The electronic device of claim 1, wherein the processor is to adjust the GUI of the conference call application based on the location of the electronic device by transmitting location information of the electronic device to the conference call application via an application programming interface (API).

4. The electronic device of claim 3, wherein the processor is to adjust the GUI of the conference call application based on the location of the electronic device by:
receiving, from the conference host device by the API, an ordered listing of conference participants; and
displaying conference participants in the GUI according to the ordered listing of conference participants.

5. The electronic device of claim 1, wherein the processor is to transmit the location of the electronic device and a request for camera zoom on the electronic device to the camera.

6. The electronic device of claim 1, wherein the processor is to exchange the location of the electronic device with a plurality of networked electronic devices and acquire a location of each of the networked electronic devices.

7. The electronic device of claim 6, wherein the processor is to adjust the GUI of the conference call application based on the location of the electronic device by:
generating, based on the location of the electronic device and the location of each of the networked electronic devices, an ordered listing of conference participants; and
displaying conference participants in the GUI according to the ordered listing of conference participants.

8. An electronic device comprising:
a microphone;
an ultra-wideband (UWB) sensor; and
a processor to:
determine a location of a camera relative to the electronic device and a location of the electronic device relative to the camera using UWB sensor information;
receive an audio input by the microphone; and
adjust a graphical user interface (GUI) of a conference call application based on the location of the electronic device and the audio input by transmitting location information including the location of the electronic device relative to the camera to the conference call application and receiving relative location information of two or more participant electronic devices from the conference call application, wherein the GUI is to be shown at the electronic device.

9. The electronic device of claim 8, wherein the processor is to determine the location of the camera relative to the electronic device by:
measuring time-of-flight (ToF) information and angle-of-arrival (AoA) information associated with individual UWB signals exchanged with the camera; and
calculating a direction and a distance of the camera relative to the electronic device based on the ToF information and the AoA information.

10. The electronic device of claim 8, wherein the processor is to adjust the GUI of the conference call application based on the location of the electronic device and the audio input by transmitting location information and audio input information of the electronic device to the conference call application by an application programming interface (API).

11. The electronic device of claim 10, wherein the processor is to transmit the audio input information of the electronic device to the conference call application responsive to the audio input meeting an audible threshold.

12. The electronic device of claim 11, wherein the processor is to adjust the GUI of the conference call application by displaying conference participants in the GUI according to an ordered listing.

13. The electronic device of claim 8, wherein the processor is to transmit the location of the electronic device and a request for camera zoom on the electronic device to the camera responsive to the audio input meeting an audible threshold.

14. The electronic device of claim 8, wherein the processor is to exchange the location of the electronic device and audio input information of the electronic device with a plurality of networked electronic devices to acquire a location and audio input information of each of the networked electronic devices.

15. The electronic device of claim 14, wherein the processor is to adjust the GUI of the conference call application based on the location of the electronic device and the audio input by:
generating, based on the location of the electronic device and the location of each of the networked electronic devices, an ordered listing of conference participants;
updating, based on the audio input information of the electronic device and the audio input information of each of the networked electronic devices, the ordered listing of conference participants responsive to an audio input of any one of the electronic devices meeting an audible threshold; and
displaying conference participants in the GUI according to the ordered listing.

16. An electronic device comprising:
an imaging sensor;
an ultra-wideband (UWB) sensor; and
a controller to:
determine, via the UWB sensor, a location of a computing device relative to the electronic device; and
transmit the location to the computing device.

17. The electronic device of claim 16, wherein the controller is to determine the location of the computing device relative to the electronic device by:
measuring time-of-flight (ToF) information and angle-of-arrival (AoA) information associated with individual UWB signals exchanged with the computing device; and
calculating a direction and distance of the computing device relative to the electronic device based on the ToF information and the AoA information.

18. The electronic device of claim 16, wherein the controller is to determine a location of each of a plurality of computing devices and transmit the determined location of each of the plurality of computing devices to one of the plurality of computing devices.

19. The electronic device of claim 16, wherein the controller is to modify a field-of-view (FoV) of the imaging sensor to the location of the computing device responsive to a request for camera zoom by the computing device.

20. The electronic device of claim 19, wherein the controller is to receive a video input comprising the FoV of the imaging sensor and provide the video input to a conference call application by an application programming interface (API).
